(19) United States
(12) Patent Application Publication
(10) Pub. No.: US 2007/0217582 A1
(43) Pub. Date: Sep. 20, 2007

(54) System for Uniquely Identifying and Reaching VOIP Users

(76) Inventor: Richard Lesser, Karlsruhe (DE)

Correspondence Address: GLENN PATENT GROUP, 3475 EDISON WAY, SUITE L, MENLO PARK, CA, 94025, US

(21) Appl. No.: 11/686,783

(22) Filed: Mar. 15, 2007

Related U.S. Application Data
(60) Provisional application No. 60/782,891, filed on Mar. 15, 2006.

(30) Foreign Application Priority Data
May 10, 2006 (EP) 06009679.9

(51) Int. Cl. H04M 15/00

(52) U.S. Cl. 379/121.04

(57) ABSTRACT

A method for setting up an account for using a voice service comprising receiving a registration request, including a telephone number or an email address belonging to a user and creating the account by storing the existing email address or the existing telephone number of the user or at least parts thereof within the account as part of the account, which is to be used for identifying the user in case of a call for the user.

### FIELD OF THE INVENTION

The present invention generally relates to a VoIP (Voice over Internet Protocol) system and, more particularly, to setting up a user account for using the VoIP system and initiating a call from an originating user to a destination user.

### BACKGROUND OF THE INVENTION

Voice over IP (Internet Protocol) is a technique yielding convergence of pure voice and data networks. With VoIP new applications in the field of telephone services are possible. Compared to classical circuit-switched telephone connections via a PSTN (Public Switched Telephone Network), VoIP solutions yield tremendous advantages in costs for companies as well as private persons. This is due to the fact, that, by using IP in a telephony infrastructure, much hardware such as switches can be eliminated, and existing computers and software can be used instead, reducing costs. However, VoIP data is latency-sensitive as it is the case for any conversational speech data. Therefore it is desirable that VoIP data shall not be unduly delayed in transmission between people conversing which each other.

To connect an originating VoIP device with a destination VoIP device, an auxiliary IP-based protocol known as Session Initiation Protocol (SIP) is used. Using a protocol such as SIP, a VoIP device is associated with an IP address and a unique identifying alphanumeric SIP address. A VoIP service provider is generally operating a server that manages an IP address corresponding to a called party's telephone number used by the VoIP service, and allowing a calling user to make a voice call over the Internet without separately managing the IP address corresponding to the called party's telephone number. Such a server is commonly called a SIP server and hence functions as a directory of end-points and their associated IP addresses and alphanumeric SIP addresses. Accordingly, to participate in an IP-based communication such as VoIP, a VoIP device must register its IP address with a SIP server. When an originating device requests a connection to an IP-based destination device, the SIP server either provides the destination IP address to the originating device, or it establishes a connection with the destination device and than acts as a proxy for the originating and destination devices, respectively.

In case an originating device belonging to a certain VoIP service system wishes to place a call to a destination device belonging to the same VoIP service system, a SIP server that is associated with the VoIP service system knows both related IP addresses and consequently establishes an IP-based connection between the two devices. On the other hand, if the destination device is not in the same VoIP service system as the originating device, its address will not appear in the SIP-server's data base, and therefore the SIP server consequently forwards the call request to other associated SIP servers until the destination address is located or until the call request has timed out.

Standard VoIP telephony calls dedicated to destinations within the same VoIP service system are connected to the destination party using Internet protocol routing techniques with the assistance of a SIP-server, as noted above. VoIP telephone calls dedicated to destinations outside of the originating VoIP service system to destinations on the PSTN require a format conversion at the boundary of the originating VoIP packet system and the which is to be used for identifying the user in case of a call for the user, identifying the destination user by comparing a part of the account having stored at least part of an email address or part of a telephone number of the destination user and the at least part of the email address or telephone number received from the originating user, and sending a message to the destination user based on the account for the identified user.

It is, therefore, an advantage of preferred embodiments of the present invention to provide a VoIP system where a user can be reached through a central server using his favorite SIP address “user@host.domain” (being the same as his email address) and not having to install the server on his own. This could e.g. be the case for a proprietary VoIP system within a company. Since the company might not want to use a public SIP server because of security or reliability issues a central server according to the embodiment of the present invention is dedicated to the VoIP system of the company, provided to the company by a third party.

It is another advantage of preferred embodiments of the present invention to provide a VoIP system where the user can be reached by one of his existing PSTN phone numbers or at least parts thereof so that no confusion between VoIP numbers and PSTN telephone numbers exists. PSTN phone numbers are typically easier to handle when using a classical hardware phone in combination with a VoIP client according to embodiments of the present invention, since a hardware phone usually only accepts numbers to be typed in as input.

It is another advantage of preferred embodiments of the present invention to provide a secure and easy method of uniquely identifying and reaching VoIP users, by providing identification of users with existing email addresses or at least parts thereof of the users and/or provide used in an existing homepage may be used as the SIP address.

VoIP call-setup is classified into several methods according to specific situations. Calling party and called party are identified by SIP addresses. To establish a call the calling party searches for the related SIP server and sends a request, i.e. an invite message, to the SIP server. The SIP server can handle this request twofold:

As a proxy server the SIP server accepts the request for connection and tries to localize the requested user to invite him. In case the destination party confirms the request for connection the proxy server routes the confirmation further to the calling party.

The second alternative is to redirect the request for a connection by obtaining potential addresses of the destination party and redirecting them to the calling client. The calling client now can send new invitation to the obtained IP addresses of the destination party.

As described before, a VoIP user can currently be uniquely identified by a uniform resource identifier (“user@host.domain”) and with that can be reached via the SIP protocol.

To provide a possibility to the said VoIP user to be reached by a different VoIP user, the administrator of a SIP server has to set up a name-server configuration in the Internet to point all SIP requests for the VoIP user to the SIP server (host.domain), and then direct all incoming calls to the VoIP user registered with this SIP server.

However, in case an administrator is not doing that, or there is no server available for that, the VoIP user cannot be reached this way. In this case the SIP address is useless and the user is not reachable through such an address. This is a big disadvantage.

### SUMMARY OF THE INVENTION

A preferred embodiment of the present invention is providing a method for setting up an account for using a voice service, the method comprising receiving a registration request, including a telephone number or an email address belonging to a user, generating a message to the user requesting the user to provide authentication information, receiving the authentication information from the user, authenticating the user using the authentication information received from the user to obtain a pass or a fail result of the authentication for the user, and creating the account only in case of a pass result for the user by storing the existing email address or the existing telephone number of the user or at least parts thereof within the account as part of the account, which is to be used for identifying the user in case of a call for the user.

Another preferred embodiment of the present invention is providing a method for setting up an account, in which the registration request is received from a provider entity having the right to provide a telephone number to a user or to provide an email address to a user or in which the registration request is received from an authorized entity being authorized by the provider entity, and the method further comprising a step of authenticating the provider entity or the authorized entity before the step of creating the account.

A preferred embodiment of the present invention is further providing a method for requesting a user account for a voice service, comprising sending a request for the account and an email or a telephone number of the user to the server, receiving a message from the server asking for authentication information, sending the authentication information to the server, and receiving a message from the server having authentication information from which the user can derive, whether a user account has been successfully set-up by the server, wherein the user account has the existing email address or the existing telephone number or at least parts thereof of the destination user within the account as part of the account, which is to be used for identifying the user in case of a call for the user.

A preferred embodiment of the present invention is further providing a method for initializing a connection between an originating user and a destination user, comprising sending at least a part of an email address or at least a part of a telephone number of the destination user to a server, and receiving a message from the server having information indicating if the server has a user account for the destination user, wherein the user account of the destination user has the existing email address or the existing telephone number or at least parts thereof of the destination user within the account as part of the account, which is to be used for identifying the user in case of a call for the user, and receiving information from the destination user, whether the destination user is available.

An additional preferred embodiment of the present invention is further providing a method for initializing a connection between an originating user and a destination user, comprising receiving a request from the originating user to connect the destination user, the request including at least a part of the telephone number or at least part of the email address, accessing a data base having an account for the destination user, wherein the user account of the destination user has the existing email address or the existing telephone number or at least parts thereof of the destination user within the account as part of the account, which is to be used for identifying the user in case of a call for the user, identifying the destination user by comparing a part of the account having stored at least part of an email address or part of a telephone number of the destination user and the at least part of the email address or telephone number received from the originating user, and sending a message to the destination user based on the account for the identified user.

It is, therefore, an advantage of preferred embodiments of the present invention to provide a VoIP system where a user can be reached through a central server using his favorite SIP address “user@host.domain” (being the same as his email address) and not having to install the server on his own. This could e.g. be the case for a proprietary VoIP system within a company. Since the company might not want to use a public SIP server because of security or reliability issues a central server according to the embodiment of the present invention is dedicated to the VoIP system of the company, provided to the company by a third party.

It is another advantage of preferred embodiments of the present invention to provide a VoIP system where the user can be reached by one of his existing PSTN phone numbers or at least parts thereof so that no confusion between VoIP numbers and PSTN telephone numbers exists. PSTN phone numbers are typically easier to handle when using a classical hardware phone in combination with a VoIP client according to embodiments of the present invention, since a hardware phone usually only accepts numbers to be typed in as input.

It is another advantage of preferred embodiments of the present invention to provide a secure and easy method of uniquely identifying and reaching VoIP users, by providing identification of users with existing email addresses or at least parts thereof of the users and/or provide identification of users with existing telephone numbers or at least parts thereof of the users.

It is hence another advantage of preferred embodiments of the present invention to provide a backup system for other SIP servers belonging to other VoIP systems where the user may by already registered, hence guaranteeing for a higher availability for the user.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which alike reference symbols indicate the same or similar components, wherein:

FIG. 1 is a diagram illustrating the authentication of a user having a certain email address at a central server;

FIG. 2 is a diagram illustrating the authentication procedure of a user providing a telephone number to a central server;

FIG. 3 is a schematic view illustrating a database within a central server;

FIG. 4 is a flow chart illustrating the initialization of a connection between an originating user and a destination user, wherein the originating user uses an email address the destination user has an identifier;

FIG. 5 is a flow chart illustrating the initialization of a connection between an originating user and a destination user, wherein the originating user uses a telephone number of the destination user as an identifier.

### DETAILED DESCRIPTION OF THE INVENTION

Hereinafter, preferred embodiments of the present invention will be described with reference to the accompanying drawings.

If it is decided that in describing the present invention below, detailed description on related known functions or a configuration makes the gist of the present invention to be unclear unnecessarily, such a detailed description will be omitted. Terms described below are terms defined in view of their functions in the present invention. The definitions above, may be varied according to user's intention and practice and should be determined based on general contents of this disclosure.

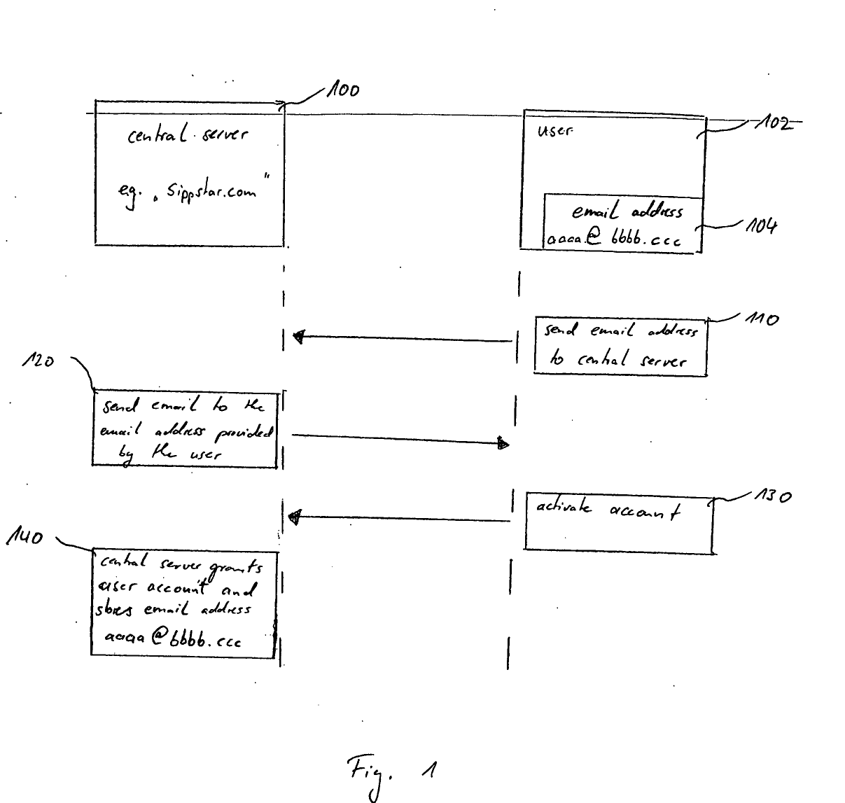

FIG. 1 shows a diagram illustrating an authentication procedure for setting up an account for using a voice service according to the present invention. For the authentication procedure a central server 100 (e.g. “sippstar.com”) is required. Furthermore, a user 102 having an existing email address 104 (e.g. “aaaa@bbbb.ccc”) who wants to register with the central server 100 is depicted.

In case the user 102 wants to set up an account for using a voice service at the central server 100 the user 102 has to provide his email address 104 to the central server 100 in a first step 110. The provision of the user's email address 104 to the central server 100 can e.g. be achieved via sending an email from the user 102 to the central server 100. In a second step 120 the central server 100 is sending an email to the user 102 requesting the user 102 to provide authentication information using a user's email address 104. Thereby the authentication information could be provided by the user 102 by sending an email to the server 100 or by accessing an authentication web-site in the world-wide-web provided by the central server. In a third step 130 the user is activating his account by providing the required authentication information to the central server 100. Finally, in a fourth step 140 the central server 100 is authenticating the user 102 using the authentication information received from the user 102 to obtain a pass or a fail result of the authentication for the user 102. In case of a pass result for the user 102 the central server 100 is creating the user account with a user account data base by storing the existing email address 104 of the user 102 or at least parts thereof within the account as a part of the account which is to be used for identifying the user 102 in case of a voice call for the user 102.

After the authentication procedure depicted in FIG. 1 the user 102 is uniquely identified by his email address 104. In case the central server 100 obtains a call request for the user 102 the call can now be directed to a VoIP client of the user 102 because the user 102 can be uniquely identified by the server 100 through his email address 104.

It is, therefore, an advantage of a preferred embodiment of the present invention to provide a VoIP system where the user 102 can be reached through the central server 100 using his favorite SIP address “user@host.domain” (being the same as his email address) and not having to install the server 100 on his own.

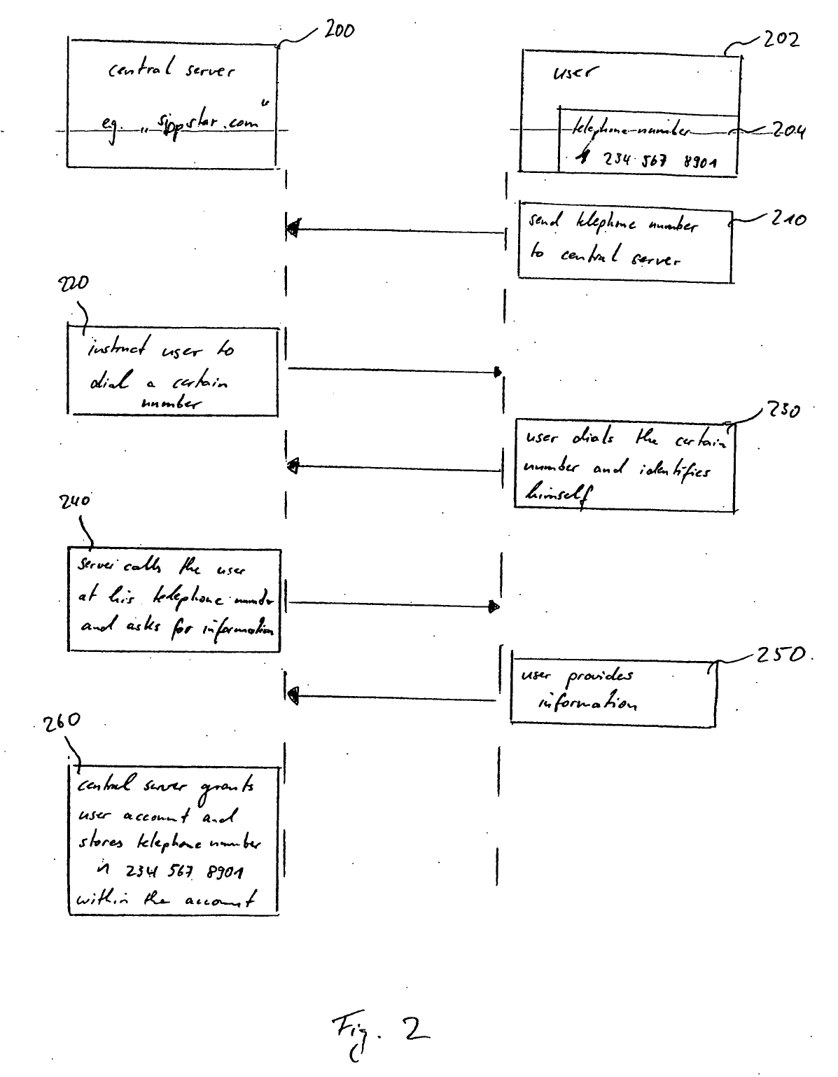

FIG. 2 illustrates a authentication situation, in which the user 202 has an existing telephone number 204 (e.g. “+1 234 567 8901”) for a PSTN which is to be registered at the central server 200. The telephone number 204 might contain a country code (e.g. “1”), an area code (e.g. “234”), a city code (e.g. “567”) and a user specific number (e.g. “8901”). The “+” represents the country code (international access code) or prefix, e.g. (011) when calling from the USA. Another example for an international telephone number could be “+49 89 12345678”, where “49” is the country code, “89” is the city or area code and “12345678” is the user specific number.

In order to set up an account for using a voice service together with an existing telephone number 204 of the user the user 202 has to provide his existing telephone number 204 to a central server 200 in a first step 210. In a second step 220 of this authentication procedure the central server 200 is instructing the user 202 to dial a certain telephone number provided by the central server 200 to the user 202. In a further step 230 the user 202 dials the telephone number provided by the central server 200 and identifies himself in an identification process. In a next step 240 the central server 200 initiates a call to the user 202 using the telephone number 204 provided by the user 202 where the user 202 is asked for additional authentication information. After the user has provided this additional authentication information in a next step 250 the central server 200 grants the account only in case of pass result for the user 202 by storing the existing telephone number 204 of the user 202 or at least parts thereof within the user account as part of the account which is to be used for identifying the user 202 in case of a call for the user 202.

It is, therefore, another advantage of a preferred embodiment of the present invention to provide a VoIP system where the user 202 can be reached by one of his existing PSTN phone numbers 204 so that no confusion between VoIP numbers and PSTN telephone numbers exists.

In another preferred embodiment of the present invention the registration request could be received from a provider entity having the right to provide a telephone number to a user, e.g. a telephone company. Likewise the registration request could be received from a provider entity having the right to provide an email address to a user, e.g. an email provider. In another case the registration request could be received from an authorized entity being authorized by a provider entity, e.g. a third party company having bought rights to use the infrastructure from a telephone company and therefore being able to offer telephone services to end-users. An authentication of the provider entity or the authorized entity before the creation of a user account could be realized e.g. by using dedicated data lines to the central server where PINs (Personal Identification Numbers) or other secret authentication information are exchanged, hence circumventing additional email or telephone traffic between the central server and the provider entity or the authorized entity.

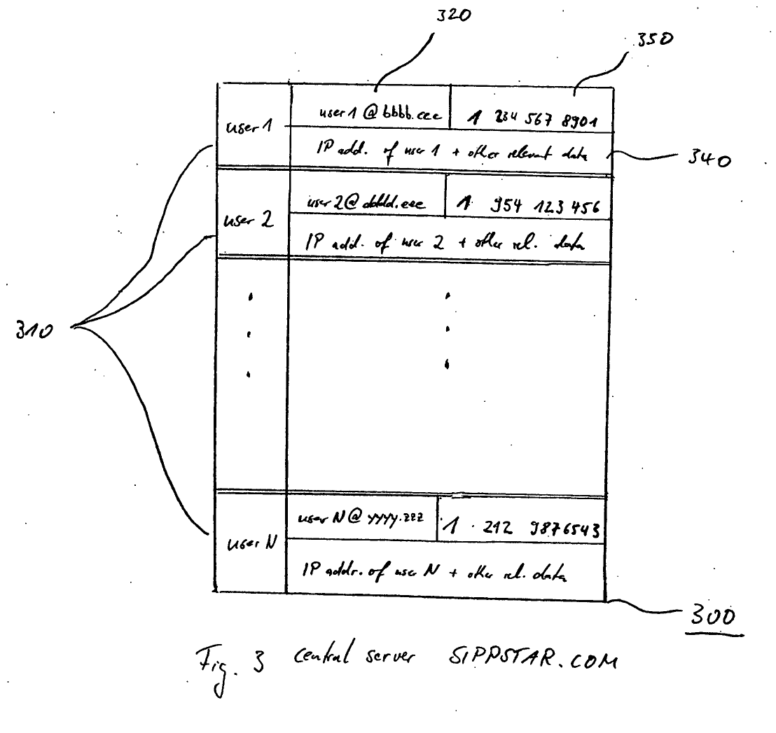

FIG. 3 is a schematic view of a user-account data base 300 which is located in a central server (“sippstar.com”) of a VoIP service system.

The user-account data base 300 comprises a plurality of accounts 310 for a plurality of users. Each of the user accounts 310 is subdivided into a plurality of user relevant data fields. For the sake of simplicity a user account 310 depicted in FIG. 3 is subdivided in a data field 320 comprising an existing email address or at least parts thereof of a specific user, in a data field 330 comprising an existing telephone number or at least parts thereof of the specific user and in a data field 340 containing the IP address of the specific user and other relevant information to set up a VoIP call. Without loss of generality the account 310 could comprise more data fields to store user relevant data.

In case a new user account 310 is created within the user account data base 300 the step of creating the user account includes a step of storing a user IP number in the data field 340 in association with the user's email address which is stored in the data field 320 and/or the telephone number which is stored in data field 330. Thereby the email address is stored as a true copy of the user's existing email address, the true copy including an “@” sign dividing a first part and a second part of the email address. The first part of the email address comprises a user identifier and the second part of the email address includes a host name and a domain identifier separated by a “.” sign. Further, the step of creating the user account 310 can include a step of storing a specific user number of a user's telephone number having a general user code and a specific user code in data field 330. Additional information different from a country code or the general user code might be also stored in data field 330 identifying a region or a large entity to which the user belongs to. Also a telephone number of the user comprising a user-specific code and a general user code could be stored in data field 330.

For each user account 310 of the user account data base 300 a data field 340 containing the IP address of the specific user and other relevant information to set up a VoIP call is required. The current IP address of the specific user is obtained each time the user newly registers with the central server “sippstar.com”.

In summary, the plurality of user accounts 310 comprising data fields for email addresses 320, data fields for telephone numbers 330, and data fields for IP addresses 340 associated with the specific users, can be seen as single look-up table entries to offer a look-up table having a plurality of entries for different users.

It is, therefore, another advantage of a preferred embodiment to provide a secure and easy method of uniquely identifying and reaching VoIP users, by providing identification of users with existing email addresses of the users and/or provide identification of users with existing telephone numbers of the users.

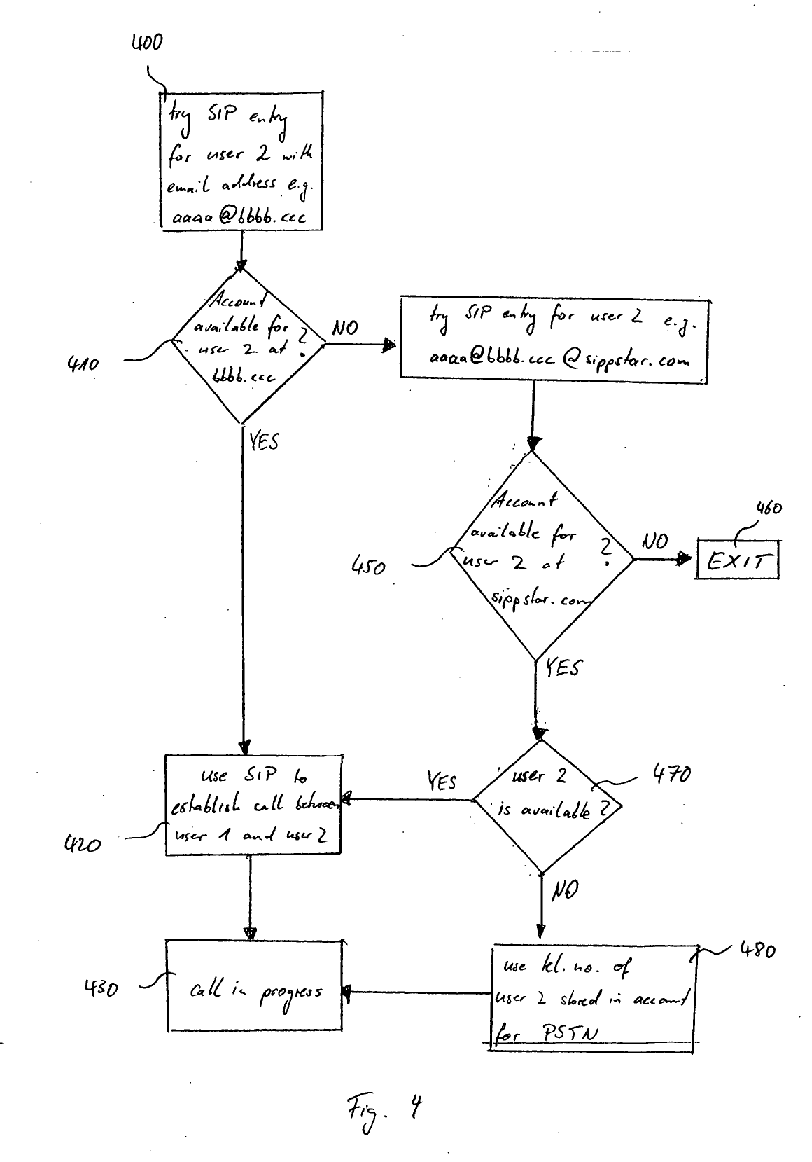

FIG. 4 illustrates a flow chart describing a situation, in which a first user having a first user client wishes to call a second user by using the email address (e.g. “aaaa@bbbb.ccc”) of the second user.

According to a preferred embodiment of the inventive method a user client of a first user uses an existing email address “aaaa@bbbb.ccc” of the second user in a first step 400 as an identifier for the second user for a SIP in order to initiate a VoIP call from the first user to the second user. Preferably, a VoIP client of the first user checks, whether a server of a provider “bbbb.ccc” already offers a VoIP communication between the first user and the second user. In the first step 400 the first user tries to establish a connection to the server “bbbb.ccc” in order to have this server check whether it has an SIP entry for the second user to be called with his existing email address “aaaa@bbbb.ccc”. This search for the destination user to be called is done by the server “bbbb.ccc” in a second step 410 and comprises the first user receiving a message from the server “bbbb.ccc” indicating whether the session with the second user can be initiated. In case the server “bbbb.ccc” finds an SIP-entry for the second user which is to be called it uses a SIP to establish a call between the first user and the second user in a third step 420. If the step 420 using the SIP has been successful then a call between the first user and the second user is set up in a last step 430.

However, in case the search for the second user at the server “bbbb.ccc” is not successful in step 410, the user client of the first user forms another SIP identifier by concatenating the existing email address “aaaa@bbbb.ccc” of the second user with a part identifying a central server “sippstar.com” by using an “@” sign dividing a first part “aaaa@bbbb.ccc” and a second part “sippstar.com” of the identifier for a SIP. This is done in step 440. Hence, step 440 includes a step of addressing the server “sippstar.com” by concatenating at least a part of the email address “aaaa@bbbb.ccc” and a part identifying the server “sippstar.com” with an “@” sign dividing a first part and a second part of an identifier for a SIP. The first part of the identifier for the SIP includes a true copy of the existing email address, the true copy of the email address including an “@” sign dividing a first part and a second part of the email address and the second part of the identifier for a session initiation protocol includes a host name “sippstar” and a domain identifier “com” divided by a ”.” sign.

In a next step 450 the central server “sippstar.com” checks whether it has stored an account comprising an IP address for the second user having the email address “aaaa@bbbb.ccc”. In case the central server finds an account for the second user by a table look-up in its data-base, it checks in step 470 whether the second user is available under the IP address stored in the second user's account. In case this table look-up is successful and the central server is able to locate the second user at the stored IP address it uses a SIP to establish a call between the calling user and the destination user in step 420, which has already been described previously. As previously, the call between the originating user and the destination user is in progress in step 430 if this Session Initiation Protocol has been successful.

Referring to step 480 which will take place if step 470 has not been successful, i.e. in case no IP address is stored for the destination user or the destination user cannot be located under the stored IP address in step 470, the central server “sippstar.com” will try to initiate a call via the Public Switched Telephone Network (PSTN) by using a telephone number of the second user stored within the destination user's account as part of the account, which is to be used for identifying the second user in case of a call for the second user to connect to a PSTN. For this purpose a so-called gateway is used to transfer the VoIP data packets into a suitable format for the PSTN. In case step 480 is successful a call between the originating user and the second user will be in progress as previously described for step 430.

It is hence another advantage of a preferred embodiment of the present invention to provide a backup system for SIP servers of distinct VoIP systems where the user may be already registered, hence guaranteeing for a higher reliability for the user.

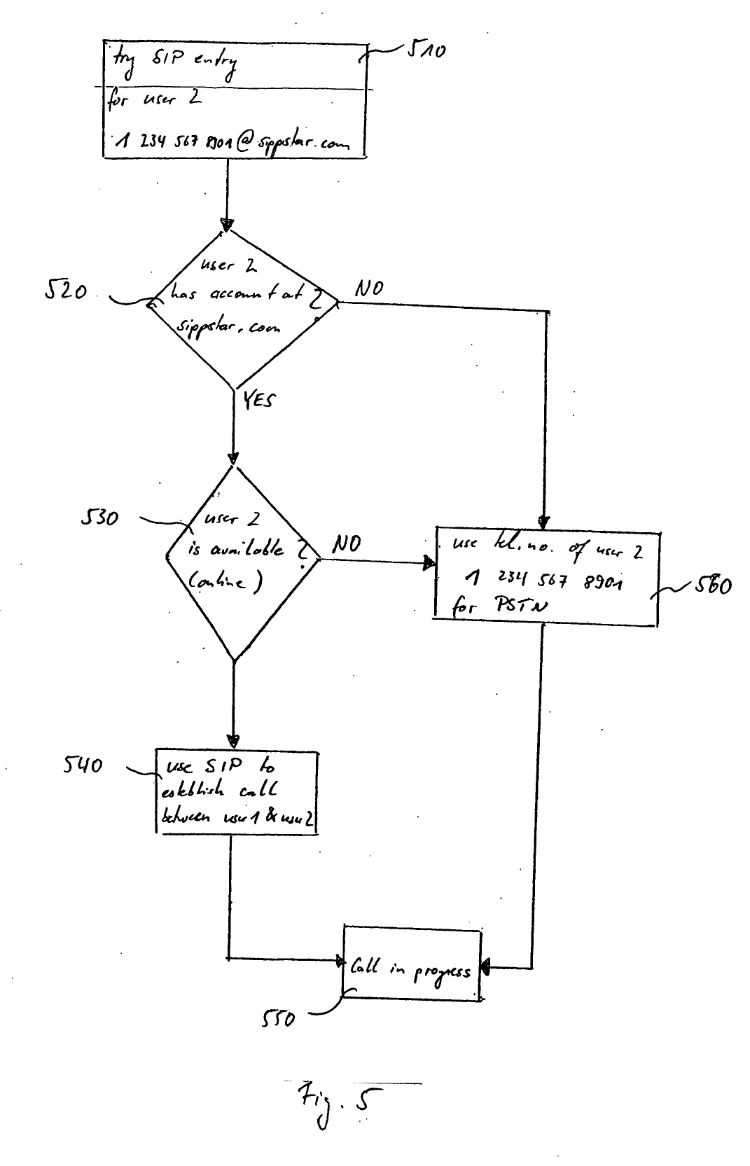

FIG. 5 shows another flow chart of a preferred embodiment of the inventive method. A procedure is shown, in which a first user wishes to have a VoIP connection to a second user. In comparison to the above described preferred embodiment the second user here is identified by a telephone number or at least parts thereof as part of an identifier for a SIP.

In a first step 510 the user client of the first user tries a SIP-entry for the second user including a telephone number of the second user, e.g. “+1 234 567 8901” concatenated with a part, e.g. “sippstar.com”, identifying the central server with an “@”-sign. i.e. the step 510 of sending at least a part of a telephone number to the server “sippstar.com” includes the step of addressing the server “sippstar.com” by concatenating at least a part of the telephone number “+1 234 567 8901” and a part identifying the server “sippstar.com” with an “@”-sign dividing a first part and a second part of an identifier for a SIP. The first part of the identifier for a SIP includes a telephone number having a general user code comprising e.g. a country code “1”, an area code “234”, a city code “567” and a specific user code “8901” and the second part of the identifier for the SIP includes a server name “sippstar” and a domain identifier “com” divided by a “.” sign.

In a second step 520 the central server “sippstar.com” checks by a table look-up in an account data-base, whether it has an account stored for the second user. The user account of the second user comprises the existing email address and/or the existing telephone number or at least parts thereof of the second user within the account as part of the account, which is to be used for identifying the second user in case of a call for the second user. In case this table look-up is successful by identifying the second user by comparing a part of the account having stored at least part of an email address or part of a telephone number of the second user and at least part of the email address or telephone number received from the first user, the central server checks whether the second user is available by applying the IP address stored in the account as part of the account of the second user and sending a message to the second user based on the IP address of the identified second user. This is done in step 530 of the depicted flow chart. In case the second user is available under the stored IP address the central server “sippstar.com” can use a SIP to establish a call between the first user and the second user in step 540. In case of success of the SIP of step 540 a VoIP-call is set up between the calling user and the second user in step 550.

In case the central server “sippstar.com” has an account for the second user but there is no IP address stored in the user account or the second user is not available under the stored IP address, the central server will use the telephone number given in step 510 as part of the SIP-identifier in a step 560 to establish a call via the Public Switch Telephone Network. For this purpose a gateway will be used in order to translate the VoIP packet data in a format suitable for PSTN. If step 560 is successful a call between the calling user and the second user can be set up in step 550, as described previously.

The central server according to the described embodiments of the present invention could be dedicated to a VoIP system of a company, provided to the company by a third party. This could e.g. be the case for a proprietary VoIP system within the company, since the company might not want to use a public SIP server because of security or reliability issues.

According to other embodiments of the present invention the central server could also be dedicated to a VoIP system within a user group, wherein the user group might be a worldwide group.

Depending on certain implementation requirements of the inventive methods, the inventive methods can be implemented in hardware or in software. The implementation can be performed using a digital storage medium, in particular a disk, DVD or a CD having electronically readable control signals stored thereon, which cooperate with a programmable computer system or by downloading the software program via a data net such as the Internet such that the inventive methods are performed. Generally, the present invention is, therefore, a computer program product with a program code stored on a machine readable carrier, the program code being operative for performing the inventive methods when the computer program product runs on a computer. In other words, the inventive methods are, therefore, a computer program having a program code for performing at least one of the inventive methods when the computer program runs on a computer.

1. Method for setting up an account (310) for using a voice service, the method comprising:
receiving a registration request, including a telephone number (204) or an email address (104) belonging to a user (102; 202);
creating the account (310) by storing the existing email address (104) or the existing telephone number (204) of the user (102; 202) or at least parts thereof within the account (310) as part of the account, which is to be used for identifying the user (102; 202) in case of a call for the user (102; 202).

2. Method according to claim 1, in which the registration request is received from a provider entity having the right to provide a telephone number to a user or to provide an email address to a user or in which the registration request is received from an authorized entity being authorized by the provider entity, and the method further comprising a step of authenticating the provider entity or the authorized entity before the step of creating the account.

3. Method according to claim 1, in which the registration request is received from the user (102; 202), the method further comprising the following steps:
generating a message to the user (102; 202) requesting the user (102; 202) to provide authentication information;
receiving the authentication information from the user (102; 202);
authenticating the user (102; 202) using the authentication information received from the user (102; 202) to obtain a pass or a fail result of the authentication for the user (102; 202),
and wherein the step of creating the account is only performed in case of a pass result for the user.

4. Method according to one of the preceding claims, in which the step of creating the account includes a step of storing a user internet protocol address of a user in association with the email address (104) or the telephone number (204) of the user.

5. Method according to one of the preceding claims, in which the step of creating the account (310) includes the step of storing the email address (104) as a true copy of the existing email address, the true copy including an “@” sign dividing a first part and a second part of the email address (104).

6. Method according to claim 5, wherein the first part of the email address (104) comprises a user identifier and the second part of the email address (104) includes a host name and a domain identifier separated by a “.” sign.

7. Method according to one of the preceding claims, in which the step of creating the account (310) includes a step of storing a specific user number of a telephone number (204) having a general user code and a specific user code, and in which the step of creating the account (310) includes the step of storing additional information different from country code or the general user code identifying a region or a large entity to which the user belongs to.

8. Method according to one of the preceding claims, in which a step of creating an account (310) includes the step of storing a telephone number (204) of the user (102; 202) comprising a user-specific code and a general user code.

9. Method according to one of the preceding claims, in which the step of creating an account (310) includes a step of entering the existing email address (104) or the existing telephone number (204) of the user or at least parts thereof into a look-up table entry reserved for the user (102; 202).

10. Method according to one of the preceding claims, in which the step of creating an account includes the step of entering the existing email address (104) or the existing telephone number (204) of the user or at least parts thereof of different users into different look-up table entries to offer a look-up table having a plurality of entries for different users.

11. Method for requesting a user account (310) for a voice service, comprising:
sending a request for the user account (310), the request having an email address (104) or a telephone number (204) of the user (102; 202) to a server (100; 200);
receiving a message from the server (100; 200) having information from which the user (102; 202) can derive, whether a user account (310) has been successfully set-up by the server (100; 200), wherein the user account has the existing email (104) address or the existing telephone number (204) or at least parts thereof of the destination user within the account (310) as part of the account, which is to be used for identifying the user (102; 202) in case of a call for the user (102; 202).

12. Method according to claim 11, in which the registration request is sent by a provider entity having the right to provide a telephone number to a user or to provide an email address to a user or in which the registration request is sent by an authorized entity being authorized by the provider entity, and the method further comprising a step of authenticating the provider entity or the authorized entity before the step of creating the account.

13. Method according to claim 11, in which the registration request is sent by the user, the method further comprising the following steps:
receiving a message from the server (100; 200) asking for authentication information;
sending the authentication information to the server (100; 200).

14. A method for initializing a connection between an originating user and a destination user, comprising:
a step (440) of sending at least a part of an email address (104) or at least a part of a telephone (204) number of the destination user to a server (100; 200);
a step (450) of receiving a message from the server (100; 200) having information indicating if the server has a user account (310) for the destination user, wherein the user account (310) of the destination user has the existing email address (104) or the existing telephone number (204) or at least parts thereof of the destination user within the account (310) as part of the account, which is to be used for identifying the user (102; 202) in case of a call for the user (102; 202), and a step (470) of receiving information from the destination user, whether the destination user is available.

15. Method according to claim 14, wherein before the step (440) of sending at least a part of an email address to the server (100; 200) two additional steps are performed:
a first additional step (400) using an existing email address (104) of a destination user as an identifier for the destination user for a session initiation protocol with a destination user;
a second additional step (410) comprising receiving a message indicating whether the session with the destination user can be initiated.

16. Method according to claim 14 or 15, wherein after the step (470) of receiving a message indicating that the destination user is not available, one additional step (480) is performed, the step using a telephone number (204) of the destination user stored within the account (310) as part (330) of the account, which is to be used for identifying the user (102; 202) in case of a call for the user (102; 202) to connect to a PSTN.

17. Method according to one of claims 14-16, in which the step (440) of sending at least a part of an email address to a server (100; 200) includes a step of addressing the server (100; 200) by concatenating at least a part of the email address (104) and a part identifying the server (100; 200) with an “@” sign dividing a first part and a second part of an identifier for a session initiation protocol.

18. Method according to claim 17, wherein the first part of the identifier for a session initiation protocol includes a true copy of an existing email address (104), the true copy of the email address including an “@” sign dividing a first part and a second part of the email address (104) and the second part of the identifier for a session initiation protocol includes a host name and a domain identifier divided by a “.” sign.

19. Method according to one of claims 14-16, in which the step of sending at least a part of a telephone number (204) to a server (100; 200) includes the step of addressing the server (100; 200) by concatenating at least a part of the telephone number (204) and a part identifying the server (100; 200) with an “@”-sign dividing a first part and a second part of an identifier for a session initiation protocol.

20. Method according to claim 19, wherein the first part of the identifier for a session initiation protocol includes a telephone number (204) having a general user code and a specific user code and the second part of the identifier for a session initiation protocol includes a server (100; 200) name and a domain identifier divided by a ”.” sign.

21. Method for initializing a connection between an originating user and a destination user, comprising:
receiving a request from an originating user to connect a destination user, the request including at least a part of the telephone number or at least part of the email address of the destination user;
accessing a data base (300) having an account (310) for the destination user, wherein the user account (310) of the destination user has the existing email address (104) or the existing telephone number (204) or at least parts thereof of the destination user within the account (310) as part (330) of the account, which is to be used for identifying the user (102; 202) in case of a call for the user (102; 202);
identifying the destination user by comparing a part of the account (310) having stored at least part of an email address (104) or part of a telephone number (204) of the destination user and at least part of the email address or telephone number received from the originating user; and
sending a message to the destination user based on the account for the identified user.

22. Method according to claim 21, wherein the step of sending a message to the destination user is based on an IP address of the destination user stored in the account (310) of the destination user as part (340) of the account.

23. Method according to claim 21, wherein the step of sending a message to the destination user is based on trying to establish a call to the destination user by a PSTN using a telephone number (204) of the destination user stored in the account (310) of the destination user as part (330) of the account.

24. Computer program having a program code for performing the method in accordance with one of the preceding claims, when the computer program runs on a computer.

25. Apparatus for setting up an account for using a voice service, the apparatus comprising:
a device for receiving a registration request, including an telephone number (204) or an email address (104) belonging to a user (102; 202);
a device for creating the account (310) by storing the existing email address (104) or the existing telephone number (204) of the user (102; 202) or at least parts thereof within the account (310) as part of the account, which is to be used for identifying the user (102; 202) in case of a call for the user (102; 202).

26. Apparatus according to claim 25, the apparatus further comprising:
a device for generating a message to the user (102; 202) requesting the user (102; 202) to provide authentication information;
a device for receiving the authentication information from the user (102; 202); and
a device for authenticating the user (102; 202) using the authentication information received from the user (102; 202) to obtain a pass or a fail result of the authentication for the user (102; 202).

27. Apparatus for requesting a user account (310) for a voice service, comprising:
a device for sending a request for the user account (310), the request having an email address (104) or a telephone number (204) of the user (102; 202) to a server (100; 200); and
a device for receiving a message from the server (100; 200) having information from which the user (102; 202) can derive, whether a user account (310) has been successfully set-up by the server (100; 200), wherein the user account (310) has the existing email address (104) or the existing telephone number (204) or at least parts thereof of the destination user within the account as part of the account (310), which is to be used for identifying the user in case of a call for the user (102; 202).

28. Apparatus according to claim 27, the apparatus further comprising:
a device receiving a message from the server (100; 200) asking for authentication information; and
a device sending the authentication information to the server (100; 200).
